(19) United States
(12) Patent Application Publication
(10) Pub. No.: US 2009/0038369 A1
(43) Pub. Date: Feb. 12, 2009

(54) MICROWAVE SYSTEM GENERATOR AND CONTROLLER FOR GAS AND LIQUID CHROMATOGRAPHY AND METHODS FOR MAKING AND USING SAME

(75) Inventor: Jan Vondras, Houston, TX (US)

Correspondence Address: ROBERT W STROZIER, P.L.L.C, PO BOX 429, BELLAIRE, TX, 77402-0429, US

(73) Assignee: PETROLEUM ANALYZER COMPANY, LP, Houston, TX (US)

(21) Appl. No.: 11/834,514

(22) Filed: Aug. 6, 2007

(51) Int. Cl. G01N 30/02; F24C 1/08

(52) U.S. Cl. 73/1.02; 250/492.1; 73/23.35

(57) ABSTRACT

A solid state, radiant energy power generator and control system for heating an object in a radiant energy cavity—a radiant energy heated oven—is disclosed, where the system includes a digital processing unit (DPU), an DPU interface, a device controller, a frequency regulator, a voltage control oscillator, a power regulator, an amplifier, and a reverse/forward power sensing means.

### BACKGROUND OF THE INVENTION

1. Field of the Invention

The present invention relates to an apparatus including a radiant energy heated oven and an radiant energy power generator and control system, especially well suited for use with gas or liquid chromatography instruments and method for making and using same.

More particularly, the present invention relates to an apparatus including a radiant energy heated oven and an radiant energy power generator and control system, where the generator and control system includes a digital processing unit (DPU), an DPU interface, a device controller, a frequency regulator, a power regulator, an amplifier, a reflected/forward power sensing means and a radiant energy cavity having two thermocouples for temperature sensing, where the system is designed to sense forward or supplied and reversed or reflected power for operation monitoring, to withstand reflected or reversed power, and to optimize oven performance during static heating and dynamic heating according to an analysis temperature profile and method for making and using same.

2. Description of the Related Art

Gas and liquid chromatography are physical methods for the separation, identification, and quantification of chemical compounds. These methods are used extensively for applications that include the measurement of product purity in analytical chemistry, the determination of environmental contamination, the characterization of natural substances, and the development of pharmaceuticals.

The fundamental methods used in gas and liquid chromatography to separate chemical constituents are similar. A sample mixture is injected into a flowing neutral carrier stream and the combination then flows through a tube or chromatographic column. The inner surface of the column is coated or packed with a material called the stationary phase. As the sample mixture and carrier stream flow through the column, the components within the mixture are retained by the stationary phase to a greater or lesser degree depending on the relative volatility (in the case of gas chromatography) or the relative solubility (in the case of liquid chromatography) of the individual components and on their respective affinities for the stationary phase. When the individual mixture components are released into the carrier stream by the stationary phase, they are swept towards the column outlet where they are detected and measured with a detector. Different chemical compounds are retained for different times by the stationary phase. By measuring the retention times, the specific compounds in the mixture can be identified. The relative concentration of the compounds is determined by comparing the peak amplitudes measured with the detector for each compound. The primary difference between gas and liquid chromatography is the mode of separation. In gas chromatography, the sample is volatilized and propelled down the analytical column by a moving stream of gas. In liquid chromatography, the sample is dissolved and propelled down the analytical column in a moving stream of liquid. Another difference between gas and liquid chromatography is that the columns used in liquid chromatography are generally filled or packed with the stationary phase, while those used in gas chromatography can also have the stationary phase coated or bonded to the interior wall, instead.

GC and LC measurements are facilitated by the application of heat to the chromatographic column to change its temperature. The use of a heated column oven in gas chromatographic systems greatly increases the number of compounds that can be analyzed and speeds up the time required for each analysis by increasing the volatility of higher molecular weight compounds. Heating an LC column affects the relative solubility of the mixture's components in the two phases and can enhance the separation as well as improve the repeatability of the elution times of the component chemicals.

Many methods have been described for heating chromatographic columns. The simplest and most commonly used method utilizes resistive heating elements to heat air which is in turn circulated through an insulated oven in which the column is placed. For example, U.S. Pat. No. 3,527,567 to Philyaw et al. describes a GC oven heated with resistive elements.

The resistive element heating method has several limitations. To achieve even heating of the column, a large volume of air is rapidly circulated around the chromatographic column. In addition to heating the column, the air heats the oven itself. Because the thermal mass of the oven is much larger than that of the column, the rate at which the column can be heated is commensurately reduced. A related problem is cooling time. After heating the oven to a high temperature during an analysis, it takes significantly longer to cool the oven plus the column to their initial temperature so that the next sample may be analyzed than it would to cool the column alone. Together, these limitations reduce the throughput of the chromatography instrument.

Attempts to localize the resistive heat element onto the column itself so as to reduce or eliminate peripheral heating of the “oven” are described in U.S. Pat. No. 3,169,389 to Green et al., U.S. Pat. No. 3,232,093 to Burow et al., and in U.S. Pat. No. 5,005,399 to Holtzclaw et al. Each of these patents describe methods for directly wrapping or cladding the chromatographic column with a resistive heating element. Methods are also described for positioning the resulting metal clad column adjacent to a cooling source to decrease cooling times. This method of heating can be difficult to implement in practice because of uneven heating of the column due to local hot or cold spots in the resistive heating element surrounding the column. Uneven heating of the column in turn compromises the quality of the analysis.

Yet another limitation of all resistively heated chromatographic devices is that if operated improperly, they can be driven to temperatures higher than the maximum tolerated by a given column resulting in damage to or destruction of the column.

An alternative method for heating chromatographic columns is microwave heating as described in U.S. Pat. No. 4,204,423 to Jordan. Potential advantages of microwave heating are efficiency and selectivity. Suitable objects placed in a microwave oven will be heated when the oven is operated, but the temperature of the oven itself will not change. Microwave heating occurs in materials which absorb the microwave energy and convert it into heat. Current chromatographic columns are generally made of materials that do not absorb microwave energy at an appreciable rate. For example, most GC capillary columns are made of polyimide and fused silica. Consequently, such columns will not heat at an appreciable rate when placed in a microwave oven. The apparatus taught by Jordan is not practicable with these columns.

Jordan teaches that any column material can be placed in a microwave oven except for conductive materials such as metals which will reflect the electromagnetic energy (by shorting out the electric field) in the microwave oven, thus rendering it inoperable. Indeed any such non-metal material can be placed in a microwave oven, but they will not necessarily be heated by the oven.

U.S. Pat. No. 3,023,835 to Brashear describes an apparatus for heating packed chromatographic columns by exposing them to radio frequency (RF) radiation. Brashear describes heating chromatographic columns via dielectric heating or via inductive heating (i.e., magnetic heating). In the case of dielectric heating, Brashear specifies that the column and the packing filler are constructed of electrically insulating materials. Most insulating materials, including those used to make chromatographic columns, do not absorb electromagnetic energy at a high enough rate to make dielectric heating as taught by Brashear practical. In the case of inductive heating, Brashear specifies that: (1) the column is constructed of a metal containing some magnetic components to enable inductive heating to occur; (2) the filler contains a metal powder to promote heat conduction from the column into the filler; and (3) the metal powder may also be magnetic to promote local inductive heating. In practice, inductive heating of the filler would not occur inside the metal column because it would be shielded from the electromagnetic field by the metal column in which it is sheathed. Moreover, metal-filled packing material inside columns is not generally a good scheme. The sample material passing down the column can be exposed to the metal. If the metal is not chemically inert, then some components of the sample can react with the metal thus distorting the resulting chromatogram.

Neither of the packed column constructions described by Brashear would be of practical usage in a microwave heating apparatus as taught by Jordan where the whole of the column is placed inside a cavity and exposed to high intensity electromagnetic radiation. The insulating low-loss column would not heat rapidly enough to be of practical use. The metal column would short out the electric field to such a significant extent that the microwave oven would not function properly and the column, if heated at all, would not be heated evenly.

Further background information can be found in U.S. Pat. Nos. 6,514,316, 6,316,759, 6,182,504, 6,093,921, 6,029,498, and 5,939,614, incorporated herein by reference.

Gas and liquid chromatography and other analyses require, in many cases, a short analysis cycle time the time span between one analysis and the next analysis. The cycle time is generally associated with heating up in a controlled fashion and cool down. The cycle time is often referred to as the time period for heating up an object and cooling it down, while a chromatographic analysis of the object is being carried out. In the case of LC and GC, the heating is designed to separate sample components as they travel through at heated chromatography column. Thus, the cycle time is the time it takes to inject a sample, heat the column, pass the sample through the heated column and cool the heated column down after the last sample components exits the column.

Such instruments also require very accurate temperature regulation and control to gain a good repeatability of chromatography results. Consequently, an increase in heating speed demands improved temperature regulation and control from the heat generating system associated with the instrument. The heat generating system for the column has been a traditional oven, but more recently, the heat generating system for the column is a microwave and radiowave oven.

Although chromatography instruments having radiant energy heat generating systems such as microwave or radiowave heat generating systems have been disclosed, there is still a need in the art for control systems for such radiant energy heat generating systems that decrease cycle time, improve sample throughput, optimize oven performance, decrease reflected radiation, increase frequency tuning of the radiant energy, and improve instrument repeatability.

### SUMMARY OF THE INVENTION

Ovens with Control and Performance Optimization System

The present invention provides a radiant energy power generating and control system for a radiant energy heated oven apparatus, where the radiant energy can be microwave, radiowave or any other radiant energy that can be used to heat a heating zone of an oven or an object in the heating zone adapted to absorb the radiant energy. The oven system includes a cavity including an object to be heated such as a chromatography column. The generating and control system includes a digital processing unit (DPU) and an interface between the digital processing unit and a control unit. The control unit includes a device controller, a frequency regulator, a voltage control oscillator, a power regulator, an amplifier, and a reverse/forward power sensing means, where the system is adapted to provide radiant energy to the cavity, to sense reflected power for operation monitoring and frequency tuning, and to optimize oven performance during static heating and/or dynamic heating according to a temperature profile. The radiant energy heated oven apparatus includes two thermocouples for temperature sensing. The power regulator or power sensing means is in analog communication with thermocouples which are used to control radiant energy heating of the object disposed within the cavity of the oven, i.e., control the amplitude, frequency and phase of the radiant energy being supplied to the cavity to heat the object therein. For microwave applications, the radiant energy power generating apparatus of this invention is adapted to operate in ISM frequency ranges.

The present invention also provides a radiant energy oven apparatus including a housing, a radiant energy cavity having an object to be heated disposed therein, and a radiant energy power generating and control system of this invention. The oven apparatus can also include an oven cooling system designed to cool the oven for faster cycling and/or sub-ambient starts and/or sub-ambient holds and/or negative temperature profiles as set forth in U.S. patent application Ser. No. 11/834,495, filed 6 August, 2007, incorporated herein by reference and/or heated transfer lines designed to maintain the transfer lines at an elevated temperature sufficient to maintain the sample in a vapor state as set forth in U.S. patent application Ser. No. 11/834,509, filed 6 Aug. 2007, incorporated herein by reference.

The present invention also provides a chromatography instrument including a sample delivery assembly. The instrument also includes a radiant energy oven apparatus including a housing, a radiant energy cavity, and a radiant energy power generating and control system of this invention. The oven apparatus can also include an oven cooling system designed to cool the oven for faster cycling and/or sub-ambient starts and/or sub-ambient holds and/or negative temperature profiles as set forth in U.S. patent application Ser. No. 11/834,495, filed 6 August, 2007, incorporated herein by reference and/or heated transfer lines designed to maintain the transfer lines at an elevated temperature sufficient to maintain the sample in a vapor state as set forth in U.S. patent application Ser. No. 11/834,509, filed 6 Aug. 2007, incorporated herein by reference. The instrument also includes a detector/analyzer assembly. The instrument can also include oxidation subassemblies and/or reduction subassemblies.

The present invention also provides a method for GC and LC chromatography including the step of regulating radiant energy power supplied to a radiant energy oven apparatus. The radiant energy oven apparatus includes a radiant energy cavity having a chromatography column disposed therein. The radiant energy oven apparatus also include a radiant energy power generating and control system of this invention, where the system improves oven performance, improves frequency tuning, improves heating and temperature control, and improves overall instrument performance.

The present invention also provides a method for performing chromatographic analyses including the step of providing an instrument of this invention with optionally cooling system and/or heated transfer lines. The method also includes the step of injecting a sample from the sample delivery system into the column inside the radiant energy cavity of the oven apparatus under conditions to affect a given separation of the components in the sample, where the oven performance is controlled by a radiant energy power generating and control system of this invention. After separation, the sample components are forwarded to the detector/analyzer assembly, which may include oxidation subassemblies and/or reduction subassemblies. After forwarding the sample components to the detector/analyzer assembly, the object is cooled with or without an option cooling assembly for the next sample injection.

### Definitions Used in the Invention

The term “temperature programmed heating profile” means a chromatography heating profile designed to achieve a desired analytical separation of components of a sample. In certain embodiments, the profiles is designed to maximize component separation. Profiles generally including at least one temperature ramp, positive or negative. The profiles can including one or a plurality of temperature holds. In certain embodiments, the temperature profile can include a sub-ambient start temperature, a sub-ambient hold temperature, or both. In other embodiments, the temperature profile can include an ambient start temperature, an ambient temperature hold or both. In other embodiments, the temperature profile can include an elevated start temperature, an elevated temperature hold or both. Thus, the profile can include a combination of start temperatures, holds, and negative and/or positive temperature ramps.

The term “positive temperature ramp” means changing a temperature from a lower temperature to a higher temperature at a desired rate. The rate can be single valued or complex meaning that the temperature can be increase at a linear rate, a combination of linear rates or a non-linear rate, where the rate is designed to achieve a given component separation.

The term “negative temperature ramp” means changing a temperature from a higher temperature to a lower temperature at a desired rate. The rate can be single valued or complex meaning that the temperature can be increase at a linear rate, a combination of linear rates or a non-linear rate, where the rate is designed to achieve a given component separation.

The term “hold” means that the column is heated to a desired temperature and held at that temperature for a desired period of time. Each hold can be held for a different period of time, where the hold times are designed to achieve a given component separation.

### BRIEF DESCRIPTION OF THE DRAWINGS

The invention can be better understood with reference to the following detailed description together with the appended illustrative drawings in which like elements are numbered the same:

FIG. 1A depicts an embodiment of a microwave generator, control, regulation, and optimization system for a microwave heated chromatography oven apparatus.

FIG. 1B depicts another embodiment microwave generator, control, regulation, and optimization system for a microwave heated chromatography oven apparatus.

FIG. 2 depicts a block diagram of a method for performing an analytical analysis using the system of FIG. 1.

FIGS. 3A-C depict block diagrams of a three embodiment of an analytical instrument including the regulator system of this invention.

### DETAILED DESCRIPTION OF THE INVENTION

The inventors have found that a solid state power system can be constructed to produce and supply radiant energy, such as microwave energy or radiowave energy, to a radiant energy resonant cavity (oven) including an object to be heated disposed therein, such a chromatography column in the case of analytical instrumentation. Reverse/reflected and forward/supplied power feedback along with frequency regulation through a frequency regulator, which can include a voltage control oscillator (VCO), is used to provide full control over a power level or amplitude and frequency of the radiant energy applied to the cavity containing the object. The feedback loop is designed to change power requirements and properties (amplitude, frequency, etc.) to adjust and/or maintain the object's temperature in accord with a temperature profile such as a temperature profile used in a chromatographic analysis. The inventor has found that the radiant energy power generating and control system of this invention has the following advantages over magnetron based power supply system: (1) simpler frequency regulation, (2) easier continuous power regulation, (3) narrower output frequency spectrum, (4) faster response, and (5) greater cost effectiveness.

The present invention broadly relates to a radiant energy heated apparatus including a radiant energy heated oven. The oven includes a cavity having an object to be heated therein. The apparatus also includes a temperature sensor disposed in the cavity or associated with the object to monitor a cavity or an object temperature. The apparatus can also include a second temperature sensor disposed in a housing surrounding the cavity to monitor oven integrity. The apparatus also includes a radiant energy power generating, controlling or regulating system. The power system includes a device controller, a frequency regulator, a power regulator, an amplifier, and a reflected/forward power sensing means, where the system is adapted to provide radiant energy to the cavity, to sense reflected and forward power for operation monitoring, and to tune the frequency and amplitude of the power supplied to the cavity to optimize oven performance during static heating and/or dynamic heating according to a temperature profile. In most embodiments, the power supply system is connected via an interface and to a digital processing unit (DPU). The interface can be wired or wireless. Wired interfaces includes an RS-232 interface, RS-422 interface, RS-423 interface, RS-449 interface, RS-485 interface, MIL-STD-188 interface, EIA-530 interface, TIA-574, or any other suitable interface between the power generating apparatus and the DPU supporting bi-directions communication. Wireless interfaces can be any wireless interface compatible with the power generating unit and the DPU, such as IR, ultrasound, near IR, or any other wireless interface.

The present invention broadly relates to a method for regulating a radiant energy supplied to a radiant energy cavity including the step of generating radiant energy and supplying the generated radiant energy to the cavity including an object to be heated. The method also includes the step of monitoring properties of the supplied radiant energy such as amplitude, frequency, etc. The method also includes the step of monitoring a temperature of the object inside the cavity. The method also includes the step of monitoring properties of supplied radiant energy and reflected radiant energy, i.e., radiant energy reflected from the oven due to imperfections in the cavity, object placement within the cavity, object size, shape and construction, and other variables that influence an amount of radiant energy reflected by the resonant cavity at a given frequency or frequency range. The method also includes the step of controlling, regulating or tuning the amplitude and frequency of the supplied radiant energy to optimize heating performance of the object in the cavity. The method also includes the step of continuously changing the amplitude and frequency range of the generated radiant energy to ensure that the object is at a desired temperature or is having its temperature changed according to a desired temperature profile, where the profile is adapted to achieve a desired separation of sample components for a sample passing through the column situated in the cavity and being exposed to the supplied radiant energy. The method can also include the step of monitoring the reflected power for any increased level of reflected power which may indicate that an oven issue (for instance lid not closed) and any changes of object or its placement (being a load for microwaves) enabling real-time system status information. The method can also include the step of frequency tuning the radiant power supplied to the cavity on a ratio of the reflected power to the supplied power. The tuning is adapted to find the best frequency or frequency range where the heated object placed in the cavity absorbs most of the energy and shows lowest reverse (reflected) power when forward power is set to a desired level. Of course, the method can also include the step of continuously frequency tuning the supplied power based on the ratio to improve oven performance when heating in accord with a given temperature profile.

The apparatuses of this invention are ideally suited for any microwave cavity (oven) that is designed to work within the given frequency range, such as an IMS frequency range. The cavities equip with power generating, controlling and regulating system of this invention are ideally well suited for used in LC and GC chromatography instruments. The system is adapted to improve oven performance which directly improves instrument performance, maintenance, repeatability, reliability, etc.

### Suitable Components

Suitable voltage control oscillators (VCOs) include, without limitations, VCOs from Synergy Microwave Corporation (USA), VCOs from Spectrum Microwave, Inc., VCOs from Norden Millimeter Inc., VCOs from Richardson Electronics, Ltd., or any other VCO capable of voltage controlled generation of radiant energy in the microwave region of the electromagnetic spectrum.

Suitable a digital processing unit (DPU) include, without limitation, any digital processing unit manufactured to execute instructions for the control, running and analytical analyses. Exemplary examples include digital processing units manufactured by Advanced Analogic Technologies, Advanced Hardware Architectures, Advanced Linear Devices, Inc., Advanced Micro Devices (AMD), Advanced Power Technology, Advanced Semiconductor, Inc, AKM Semiconductor, Inc., Alcor Micro Corp, Allegro MicroSystems, Inc., Alliance Semiconductor Corp., AMIC Technology Corporation, Anachip Corp., Anadigics, Inc., Analog Devices, Apex Microtechnology Corp., Atmel Corporation, AUK Co., Ltd., Austria Mikro Systeme Int., Beyond Innovation Technology Co, BI Technologies, Burr-Brown Corp., California Micro Devices, Calogic, LLC, Cherry Semiconductor, Chino-Excel Technology Corp., Chrontel, Inc., Cirrus Logic, COMedia Ltd., Consumer Microcircuits Limited, Continental Device India Ltd, Cypress Semiconductor, Daewoo Semiconductor, Dallas Semiconductor, Davicom Semiconductor, Inc., Diotec Elektronische, ELAN Microelectronics Corp., Electro Sonic Inc., Ericsson Microelectronics, Exar, Fairchild Semiconductor, Fuji Electric Co., Fujitsu Microelectronics, General Semiconductor, Gennum Corporation, Harris Semiconductor, Hitachi Semiconductor, HOLT Integrated Circuits Inc., Holtek Semiconductor Inc., IC Plus Corp., Infineon Technologies AG, Information Storage Devices, Integrated Device Technology, Intel, International Rectifier, Intersil Corp., Isahaya Electronics Corporation, Korea Electronics Co., Ltd., Lambda Advanced Analog Inc., Lattice Semiconductor Corp., Level One Communications, Linear Integrated System, Inc., Linear Technology, M/A-COM, Marktech Optoelectronics, Maxim Integrated Products, Micro Linear Corp., Microchip Technology, Inc., Micronas Intermetall, Microsemi Corp., Mitel Semiconductor, Mitsubishi Electric Corp., Mosel Vitelic, Motorola, MX-COM, Inc., National Semiconductor, NEC Electronics Inc., New Japan Radio Co., Ltd., O2 Micro, Inc., ON Semiconductor, Panasonic (Matsushita), Philips Semiconductors, Plessey Semiconductors, Power Innovations, Princeton Technology Corp., Ramtron International Corp., Retec-Korus JSC, RF Micro Devices, Ricoh Company, Ltd., ROHM Co., Samsung Electronic, Sanken Electric Co., SanRex, SANYO Electric Co., Ltd., Seiko Epson Corporation, Seiko Epson Corporation, Semelab Plc., Semikron International, SemiWell Semiconductor Co., Semtech Corp., SGS-Thomson Microelectronics, Sharp, Shindengen Electric, Siemens, Silicon Integrated System Corp., Silicon Laboratories, Silicon Storage Technology, Inc, Sipex Corporation, Solid State Micro Technology, SONY Semiconductors, Standard Microsystems Corp., System General (SG), TDK Semiconductor, TelCom Semiconductor Inc., Texas Instruments, THAT Corporation, Torex Semiconductor, Toshiba, TriQuint Semiconductor, United Microelectronics Corp., Unitrode Semiconductor Products, Vishay Telefinken, VLSIVision Ltd., Watkins-Johnson (WJ) Company, Winbond Electronics, Wing Shing Electronic Co., Xemics, Z-Communications, Inc., Zetex Semiconductors, ZILOG, or other chip manufacturers.

Suitable interfaces include, without limitation, any interface and interface protocol sufficient to interconnected and permit communication between the DPU and the other components of the generating, controlling and regulating system of this invention.

Suitable device controllers include, without limitation, any controller capable of controlling the components of the generating, controlling and regulating system of this invention.

Suitable frequency regulators include, without limitation, any frequency regulator capable of regulating the frequency of radiant energy supplied to the cavity.

Suitable power regulators include, without limitation, any power regulator capable of regulating the power of the radiant energy supplied to the cavity.

Suitable amplifiers include, without limitation, any amplifier capable of amplifying the power to supplied the desired power level to the cavity.

Suitable a reverse/forward power sensing means include, without limitation, any reverse/forward power sensors capable of accurately sensing the supplied radiant energy to the cavity and the radiant energy reflected back toward the generator by the cavity.

### Generating, Controlling and Regulating Systems

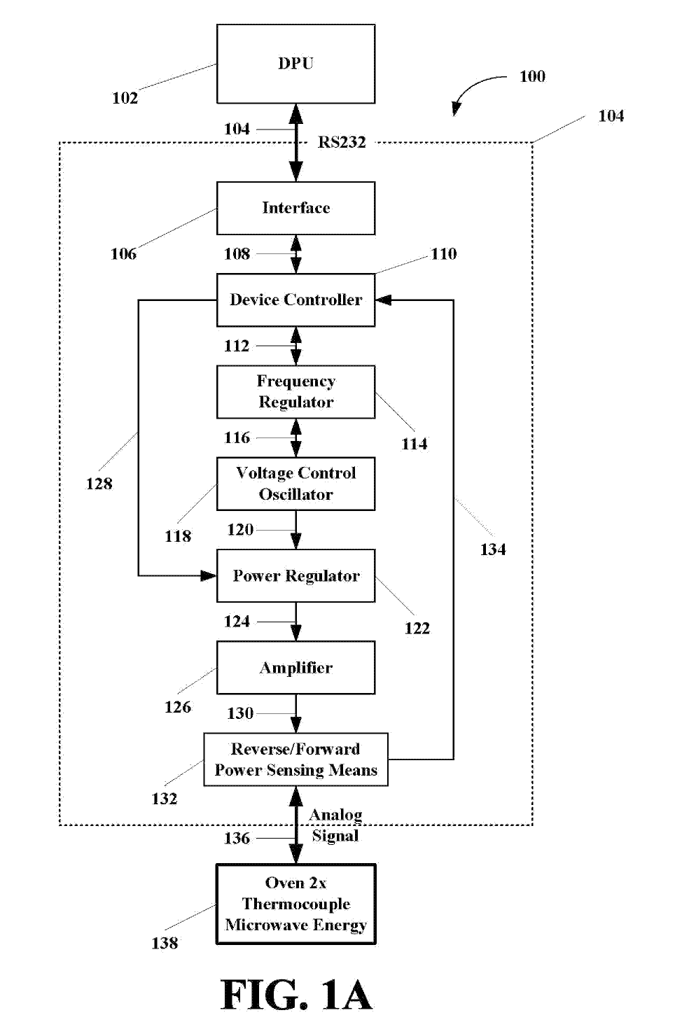

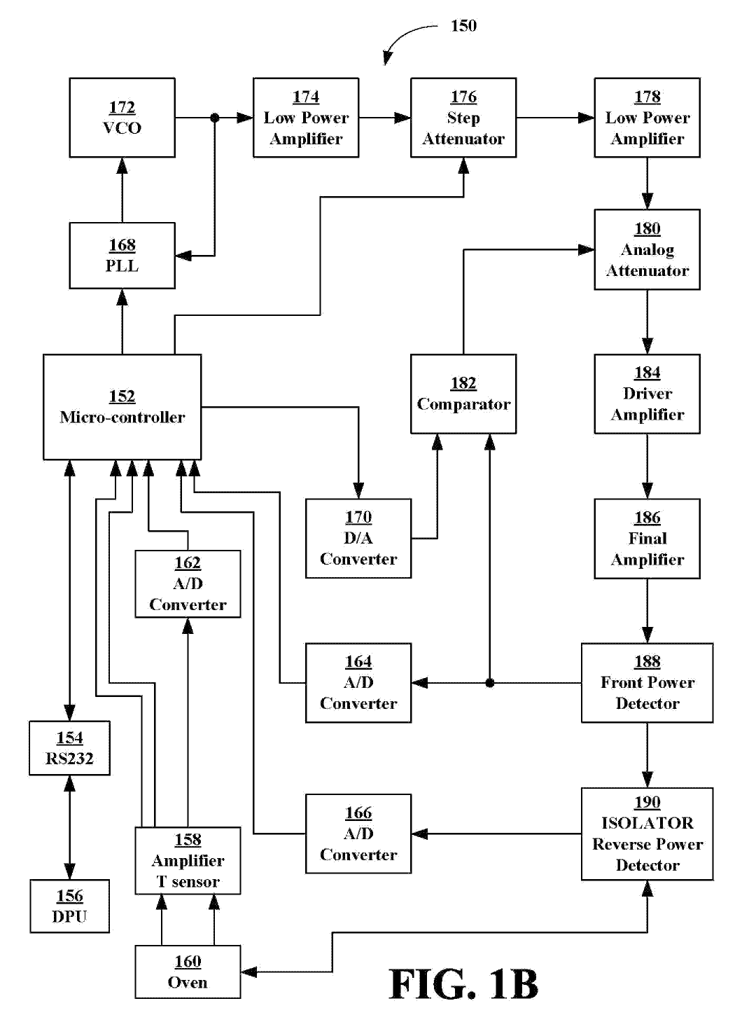

Referring now to FIG. 1A, a generalized embodiment of a solid-state, generating, controlling and regulating system of a microwave oven apparatus of this invention, generally 100, is shown to include a system computer or digital processing unit (DPU) 102. The DPU 102 is connected by a connection 104 such as a RS232 connection cable. The connection 104 connects the DPU 102 to an interface 106. The interface 106 is connected via an interface connection 108 to a device controller 110. The device controller 110 is connected via a controller connection 112 to a frequency regulator 114. The frequency regulator 114 is connected via a regulator connection 116 to a voltage control oscillator (VCO) 118. The VCO 118 is connected via a VCO connection 120 to a power regulator 122. The power regulator 122 is connected via a power regulator connection 124 to an amplifier 126 and via a second controller connection 128 to the device controller 110. The amplifier 128 is connected via an amplifier connection 130 to a reverse/forward power sensing means 132. The means 132 is connected via a first means connection 134 to the controller 110 and via a bidirectional analog connection 136 to a microwave oven apparatus 138 including two thermocouples (not shown). One thermocouple is disposed in a heating zone of the oven apparatus 132, while the second thermocouple is disposed in a wall of the oven apparatus 132 for temperature control, frequency tuning and power control.

Referring now to FIG. 1B, a specific embodiment of a generating, controlling and regulating system of a microwave oven apparatus of this invention, generally 150, is shown to include a micro-controller 152. The micro-controller 152 is connected, via a RS232 cable 154, to a DPU 156 in a bidirectional communication protocol input and output information is exchanged. The micro-controller 152 is connected, in an input format, to a thermocouple amplifier 158, which is connected to thermocouples in a microwave cavity (oven) 160 in an input format and to a first analog to digital (A/D) converter 162, which is in turn connected to the thermocouple amplifier 158 in an input format. The micro-controller 152 is also connected, in an intput format, to a second A/D converter 164 and a third A/D converter 166. The micro-controller 152 is also connected, in an output format, to a phase-lock loop (PLL) 168 and a digital to analog (D/A) converter 170. The PLL 168 is connected, in an output format, to a voltage control oscillator (VCO) 172 and, in an input format, to the VCO output 172. The VCO 172 is connected, in an output format, to a first low power amplifier 174 and to the PLL 168. The low power amplifier 174 is connected, in an output format, to a step attenuator 176. The step attenuator 176 is connected, in an output format, to a second low power amplifier 178 and in an input format, to the micro-controller 152 so that the step attenuator 176 receives inputs from both the micro-controller 152 and the first low power amplifier 174. The second low power amplifier 178 is connect, in an output format, to an analog attenuator 180. The analog attenuator 180 is connected, in an input format, to a comparator 182 and, in an output format, to a driver amplifier 184. The comparator 182 is connected, in an input format, to the D/A converter 170 and in an output format to the analog attenuator 180. The driver amplifier 184 is connected, in an output format, to a final amplifier 186. The final amplifier 186 is connected, in an output format, to a front power detector 188 and, in an input format, to the second A/D converter 164 and to the comparator 182. The front power detector 188 is connected, in an output format to an isolator/reflected power detector 190. The isolator/reflected power detector 190 is connected, in an output format, to the third A/D converter 166 and to the oven 160, where the connection to the cavity 160 transmits the supplied radiant energy to the cavity 160 and transmits the reflected power from the cavity 160 to the isolator/reflected power detector 190.

It should be recognized that the present generating, controlling and regulating system can be used with any radiant energy system including a radiowave oven. The system can also be used in radiant energy oven used in other applications besides use in analytical instruments. Thus, the system can be used to control and regulate radiant energy fields used in any type of radiant energy application that requires precise control of power and frequency of a specific wave length range of radiant energy and for optimizing oven performance by decreasing reflected power and optimizing the frequency range for the cavity receiving the radiant energy.

### Method for Generating, Controlling and Regulating a Microwave Oven

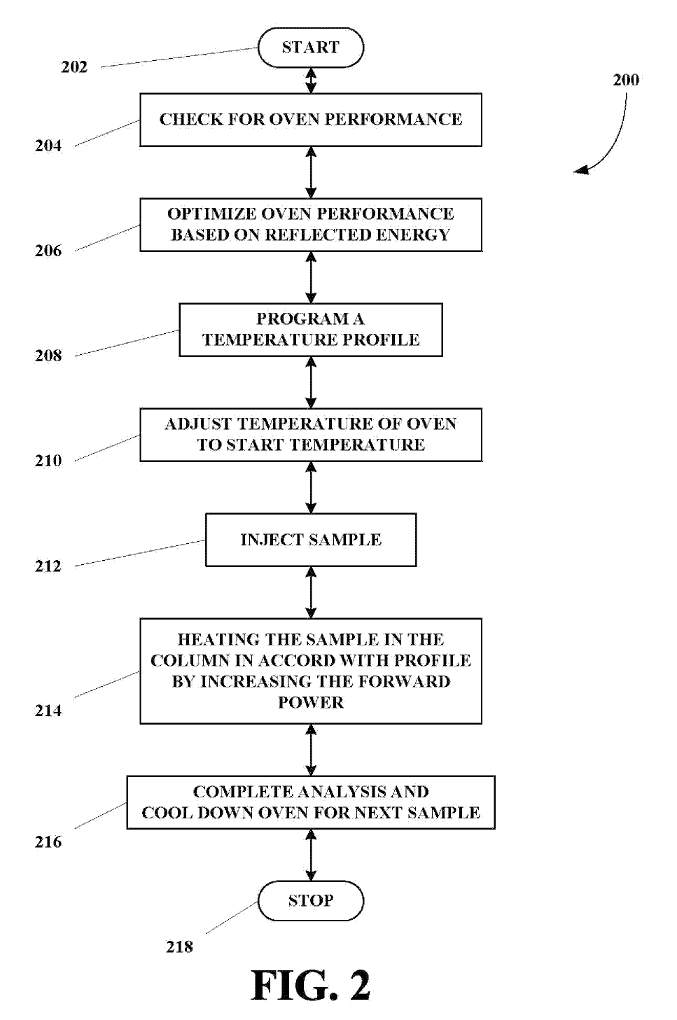

Referring now to FIG. 2, a block diagram of a method for generating, controlling and regulating microwave energy supplied to a microwave oven apparatus, generally 200. The method 200 includes a start step 202. Once started, the method 200 checks the microwave oven for performance properties in a check step 204. If the oven door is opened, then the check oven performance step 204 will so notify the user. The check step 204 will also check for other performance problems and to report them to the user for correction, before continuing to the next step. Next, the method 200 optimizes oven performance by tuning the frequency of the microwave energy being supplied to the oven based on an amount of supplied power, on an amount of reflected power and/or on a ratio of supplied power to reflected power in an optimize step 206. The optimization step 206, i.e., the step 206 adjusts power and/or microwave frequency to obtain optimum oven performance. Next, the method 200 includes a user programs a desired temperature profile in a program step 208. It should be recognized by an ordinary artisan that this step can be performed at any time prior to the next step, which start to perform the profile. The profile can be user provided or provided by the computer. The temperature profile includes a start temperature, a final temperature and at least one temperature ramp for increasing the oven temperature from the start temperature to the final or stop temperature. The profile can also include a plurality of temperature ramps (both negative and positive) and one or a plurality of temperature holds. The profile can be fairly simple or very complex depending on the sample and on the type of separation desired.

Next, the method 200 adjusts the oven temperature to the desired start temperature in an adjust temperature step 210. Once the chromatography column within the oven is at the start temperature, a sample is injected into the column in an inject step 212. After sample injection, the temperature of the column is changed in accord with the temperature profile in a change step 214. The change step 214 involves changing a amplitude of the power supplied to the oven in accord with the profile. The change step 214 can also include changing the frequency of the supplied radiation to optimize column. Next, the profile is completed in a complete analysis step 216 and the oven is cooled down for the next sample. Finally, the method 200 includes a stop step 218, which permits a new analysis to be started. Of course, if the method is for in-line analysis or a collection of samples are to be analyzed using the same temperature profile, then after the complete step 216, control can be sent to the adjust temperature step 210 for the next sample. The method would then stop, when the user issues a stop command.

### Instruments Utilizing the Generating, Controlling and Regulating System

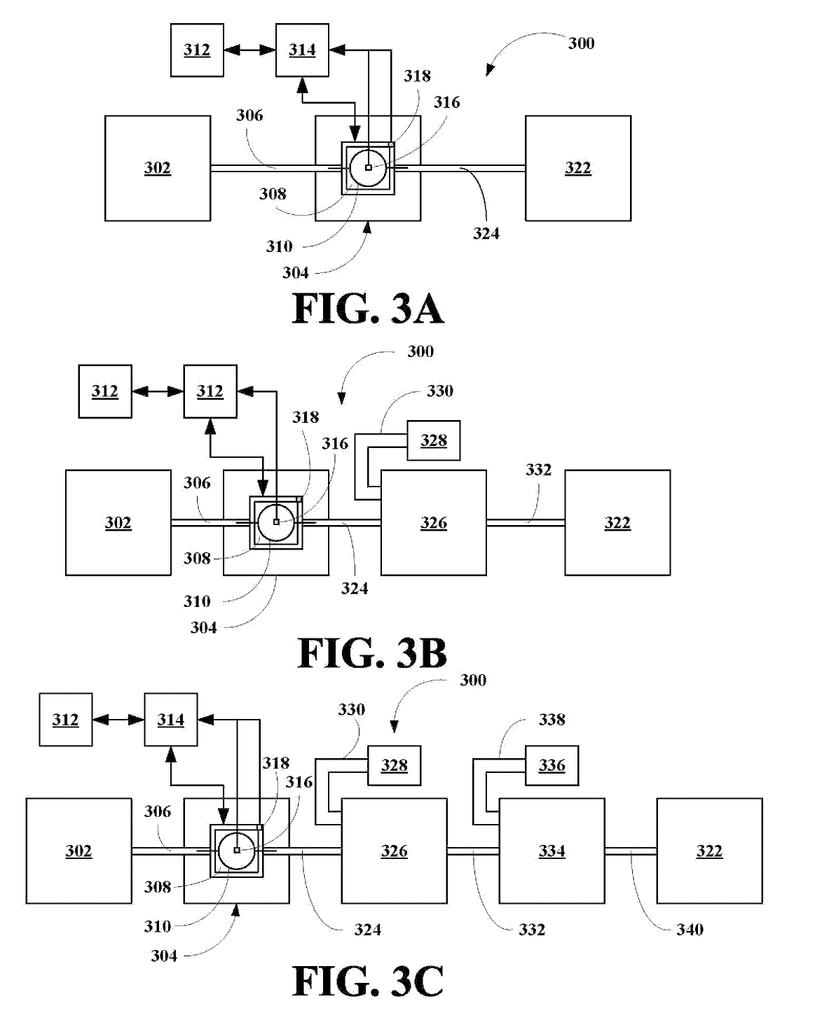

Referring now to FIG. 3A, an embodiment of an analytical instrument of this invention, generally 300, is shown to include a sample supply assembly 302 and a microwave oven apparatus 304, where the sample supply assembly 302 is adapted to forward a sample to the oven apparatus 304 via sample path 306. The oven apparatus 304 includes a heating zone 308 with a chromatographic column 310 disposed inside the zone 308. The apparatus 300 also includes a digital processing unit (DPU) 312 in bi-directional (I/O) communication with a solid-state, oven controller 314. The controller 314 is in communication with a first oven thermocouple 316 disposed into or in direct thermal contact with the heating zone 308 and with a second oven thermocouple 318 disposed in a wall 320 of the oven 304. The first thermocouple 316 is designed to provide the controller 314 with temperature data for the oven apparatus 304 so that the temperature in the heating zone 308 can be controlled. The second thermocouple 318 is adapted to supply the controller 314 with data concerning certain oven attributes, such as whether the oven door is properly closed, whether the column is properly disposed in the heating zone of the oven 304, or other oven attributes that may adversely affect the operation of the oven 304. The controller 314 is also connected to the oven 304 to supply radiant energy to the oven 304 and to receive reflected radiant energy from the oven 304. An intensity of the reflected radiant energy is used by the controller 314 to adjust an amplitude and frequency of the radiant energy supplied to the oven 304 to optimize oven performance. The DPU 312 is adapted to receive a user defined temperature profile and sending the profile to the controller which then generates radiant energy optimized to cause the oven and the column therein to undergo the desired temperature profile. The controller 314 continuously optimized the amplitude and frequency of the supplied radiant energy so that the profile is executed with optimum precision.

The system 300 also includes a detection/analyzer assembly 322 connected to the oven apparatus 304 via a oven output path 324. The sample supply assembly 302 can be a single port injector, a automated sample injector system, a sample loop, an in-line sample loop, an automated sample loop apparatus for forwarding numerous samples to the column, or any other sample supply assembly used in analytical instruments now or will be used in the future. The detector/analyzer assembly 322 can be any now know or yet to be developed oxide detection and analyzing system including, without limitation, IR spectrometers, FTIR spectrometers, MS spectrometers, Uv spectrometers, UV fluorescence spectrometers, ICR spectrometers, any other spectrographic detection and analyzing system or mixtures or combinations thereof.

Referring now to FIG. 3B, another embodiment of an instrument of this invention, generally 300, is shown to include a sample supply assembly 302 and a microwave oven apparatus 304, where the sample supply assembly 302 is adapted to forward a sample to the oven apparatus 304 via sample path 306. The oven apparatus 304 includes a heating zone 308 with a chromatographic column 310 disposed inside the zone 308. The apparatus 300 also includes a digital processing unit (DPU) 312 in bidirectional (I/O) communication with a solid-state, oven controller 314. The controller 314 is in communication with a first oven thermocouple 316 disposed into or in direct thermal contact with the heating zone 308 and with a second oven thermocouple 318 disposed in a wall 320 of the oven 304. The first thermocouple 316 is designed to provide the controller 314 with temperature data for the oven apparatus 304 so that the temperature in the heating zone 308 can be controlled. The second thermocouple 318 is adapted to supply the controller 314 with data concerning certain oven attributes, such as whether the oven door is properly closed, whether the column is properly disposed in the heating zone of the oven 304, or other oven attributes that may adversely affect the operation of the oven 304. The controller 314 is also connected to the oven 304 to supply radiant energy to the oven 304 and to receive reflected radiant energy from the oven 304. An intensity of the reflected radiant energy is used by the controller 314 to adjust an amplitude and frequency of the radiant energy supplied to the oven 304 to optimize oven performance. The DPU 312 is adapted to receive a user defined temperature profile and sending the profile to the controller which then generates radiant energy optimized to cause the oven and the column therein to undergo the desired temperature profile. The controller 314 continuously optimized the amplitude and frequency of the supplied radiant energy so that the profile is executed with optimum precision.

The system 300 also includes an oxidation unit 326, where the oxidation unit 326 is connected to the oven apparatus 304 by the oven output path 324. The oxidation unit 326 includes an oxidizing agent supply 328 and a conduit 330 connecting the oxidizing agent supply 328 to the oxidation unit 326. The system 300 also includes a detection/analyzer assembly 322, where the assembly 322 is connected to the oxidation unit 326 via an oxidation unit output path 332. The oven output path 324 leading to the oxidation unit 326 can include a mixing or nebulizing unit (not shown) immediately upstream of the oxidation or combustion unit 326 adapted to supply a thoroughly mixed sample and oxidizing agent mixture to the combustion unit 326 or an atomized sample and oxidizing agent mixture to the combustion unit 326. The sample supply assembly 302 can be a single port injector, a automated sample injector system, a sample loop, an in-line sample loop, an automated sample loop apparatus for forwarding numerous samples to the column, or any other sample supply assembly used in analytical instruments now or will be used in the future. The detector/analyzer assembly 322 can be any now know or yet to be developed oxide detection and analyzing system including, without limitation, IR spectrometers, FTIR spectrometers, MS spectrometers, UV spectrometers, UV fluorescence spectrometers, chemiluminescence spectrometers, ICR spectrometers, any other spectrographic detection and analyzing system or mixtures or combinations thereof. If the detection system includes a chemiluminescent detector, then detector will also include a source of ozone and associated conduits between the ozone generator and the detector.

Referring now to FIG. 3C, another embodiment of an instrument of this invention, generally 300, is shown to include a sample supply assembly 302 and a microwave oven apparatus 304, where the sample supply assembly 302 is adapted to forward a sample to the oven apparatus 304 via sample path 306. The oven apparatus 304 includes a heating zone 308 with a chromatographic column 310 disposed inside the zone 308. The apparatus 300 also includes a digital processing unit (DPU) 312 in bi-directional (I/O) communication with a solid-state, oven controller 314. The controller 314 is in communication with a first oven thermocouple 316 disposed into or in direct thermal contact with the heating zone 308 and with a second oven thermocouple 318 disposed in a wall 320 of the oven 304. The first thermocouple 316 is designed to provide the controller 314 with temperature data for the oven apparatus 304 so that the temperature in the heating zone 308 can be controlled. The second thermocouple 318 is adapted to supply the controller 314 with data concerning certain oven attributes, such as whether the oven door is properly closed, whether the column is properly disposed in the heating zone of the oven 304, or other oven attributes that may adversely affect the operation of the oven 304. The controller 314 is also connected to the oven 304 to supply radiant energy to the oven 304 and to receive reflected radiant energy from the oven 304. An intensity of the reflected radiant energy is used by the controller 314 to adjust an amplitude and frequency of the radiant energy supplied to the oven 304 to optimize oven performance. The DPU 312 is adapted to receive a user defined temperature profile and sending the profile to the controller which then generates radiant energy optimized to cause the oven and the column therein to undergo the desired temperature profile. The controller 314 continuously optimized the amplitude and frequency of the supplied radiant energy so that the profile is executed with optimum precision.

The system 300 also includes an oxidation unit 326, where the oxidation unit 326 is connected to the oven apparatus 304 by the oven output path 324. The oxidation unit 326 includes an oxidizing agent supply 328 and a conduit 330 connecting the oxidizing agent supply 328 to the oxidation unit 326. The system 300 also includes a reduction unit 334, where the reduction unit 334 is connected to the oxidation unit 326 via the oxidation unit output path 332. The reduction unit 334 includes a reducing agent supply 336 and a conduit 338 connecting the reducing agent supply 336 to the reduction unit 334. The system 300 also includes a detection/analyzer assembly 322, where the assembly 322 is connected to the reduction unit 334 via a reduction unit output path 340. The oven output path 324 can include a mixing or nebulizing unit (not shown) immediately upstream of the oxidation or combustion unit 326 adapted to supply a thoroughly mixed sample and oxidizing agent mixture to the combustion unit 326 or an atomized sample and oxidizing agent mixture to the combustion unit 326. The sample supply assembly 302 can be a single port injector, a automated sample injector system, a sample loop, an in-line sample loop, an automated sample loop apparatus for forwarding numerous samples to the column, or any other sample supply assembly used in analytical instruments now or will be used in the future. The detector/analyzer assembly 322 can be any now know or yet to be developed oxide detection and analyzing system including, without limitation, IR spectrometers, FTIR spectrometers, MS spectrometers, Uv spectrometers, Uv fluorescence spectrometers, chemiluminescence spectrometers, ICR spectrometers, any other spectrographic detection and analyzing system or mixtures or combinations thereof. If the detection system includes a chemiluminescent detector, then detector will also include a source of ozone and associated conduits between the ozone generator and the detector.

All references cited herein are incorporated by reference. Although the invention has been disclosed with reference to its preferred embodiments, from reading this description those of skill in the art may appreciate changes and modification that may be made which do not depart from the scope and spirit of the invention as described above and claimed hereafter.

I claim:

1. A radiant energy power generating apparatus comprising:
a controller including a bi-direction, digital processing unit (DPU) interface,
a frequency regulator,
a power regulator,
an amplifier,
a reflected and forward power sensing means, and
an analog input for at least one temperature sensor,
where the apparatus is adapted to supply an optimized radiant energy field to a radiant energy cavity so that an object disposed within the cavity can be heated in accordance with a heating profile.

2. The apparatus of claim 1, wherein the radiant energy is microwave energy, radiowave energy or any other radiant energy capable of heating the heated zone.

3. The apparatus of claim 2, wherein the radiant energy is microwave energy.

4. The apparatus of claim 3, wherein the apparatus is a chromatography instrument and the object is a chromatography column.

5. The apparatus of claim 4, further comprising:
a sample delivery system and
a detector/analyzer system,
where the sample delivery system is adapted to deliver a sample to the column disposed in the oven and where the detector/analyzer system is adapted to detect sample components as they exit the column.

6. The apparatus of claim 5, further comprising:
an oxidizing system disposed upstream of the detector/analyzer,
where the oxidizing system is adapted to convert a portion of the component into their corresponding oxides and the detector/analyzer system is adapted to detect one or more oxidized sample components as they exit the oxidizing system.

7. The apparatus of claim 6, further comprising:
a reducing system disposed upstream of the detector/analyzer and downstream of the oxidizing system,
where the reducing system is adapted to convert a portion of the oxidized component into their corresponding reduced species and the detector/analyzer system is adapted to detect one or more reduced species as they exit the reducing system.

8. A radiant energy power generator and regulator apparatus comprising:
a micro-controller including a bi-directional digital processing unit interface,
a temperature sensor amplifier in input communication with at least one temperature sensor disposed in a radiant energy cavity and output communication with the micro-controller,
a first analog to digital (A/D) converter in input communication with the temperature sensor amplifier and output communication with the micro-controller and adapted to convert an analog temperature sensor output into a digital temperature sensor output,
a phase-lock loop in output communication with the micro-controller adapted to control a phase of the radiant energy generated by the apparatus,
a voltage control oscillator in input communication with the phase-lock loop and output communication with the phase-lock loop,
a first low power amplifier in input communication with the voltage control oscillator,
a step attenuator in output communication with the first low power amplifier,
a second low power amplifier in output communication with the step attenuator,
an analog attenuator in output communication with the second low power amplifier,
a driver amplifier in output communication with the analog attenuator,
a final amplifier in output communication with the driver amplifier,
a front power detector in output communication with the final amplifier,
an isolator, reverse power detector in output communication with the front power detector and in radiant energy communication with a radiant energy cavity,
a digital to analog converter in output communication with the micro-controller,
a comparator in output communication with the digital to analog converter and the front power detector, the comparator output is input to the analog attenuator,
a second A/D converter in output communication with the micro-controller and in input communication with the front power detector,
a third A/D converter in output communication with the micro-controller and in input communication with the isolator,
where the apparatus is adapted to supply an optimized radiant energy field to the radiant energy cavity so that an object disposed within the cavity can be heated in accordance with a heating profile.

9. The apparatus of claim 8, wherein the radiant energy is microwave energy, radiowave energy or any other radiant energy capable of heating the heated zone.

10. The apparatus of claim 9, wherein the radiant energy is microwave energy.

11. The apparatus of claim 10, wherein the apparatus is a chromatography instrument and the object a chromatography column.

12. The apparatus of claim 11, further comprising:
a sample delivery system and
a detector/analyzer system,
where the sample delivery system is adapted to deliver a sample to the column disposed in the oven and where the detector/analyzer system is adapted to detect sample components as they exit the column.

13. The apparatus of claim 12, further comprising:
an oxidizing system disposed upstream of the detector/analyzer,
where the oxidizing system is adapted to convert a portion of the component into their corresponding oxides and the detector/analyzer system is adapted to detect one or more oxidized sample components as they exit the oxidizing system.

14. The apparatus of claim 13, further comprising:
a reducing system disposed upstream of the detector/analyzer and downstream of the oxidizing system,
where the reducing system is adapted to convert a portion of the oxidized component into their corresponding reduced species and the detector/analyzer system is adapted to detect one or more reduced species as they exit the reducing system.

15. A method comprising the steps of:
checking a radiant energy heated cavity for cavity integrity and proper placement of an object in the cavity,
notifying a user of any problems with the cavity or the object placement inside the cavity,
supplying radiant energy to the cavity at a desire power level and within a desired radiant energy frequency range,
measuring the supplied power and a reflected power,
adjusting the power and/or radiant energy frequency range supplied to the cavity to optimize cavity performance and object heating,
changing the object to a start temperature according to a user supplied or automated temperature profile,
adjusting the power or power and frequency of the supplied energy to change the temperature of the object according to the profile until a final temperature is attained, and
ceasing the supply of power to the cavity allowing the object to cool.

16. The method of claim 15, wherein the radiant energy is microwave energy, radiowave energy or any other radiant energy capable of heating the heated zone.

17. The method of claim 16, wherein the radiant energy is microwave energy.

18. The method of claim 17, wherein the cavity comprises:
a microwave oven including a chromatography column disposed therein.

19. The method of claim 18, further comprising the steps of:
prior to heating according to the profile, delivering a sample to the column from a delivery system, where the column and the profile are adapted to achieve a desired separation of sample components, and
after separation in the column, forwarding the components to a detector/analyzer system, where the detector/analyzer system is adapted to detect sample components as they exit the column.

20. The method of claim 19, further comprising the step of:
prior to the forwarding step, oxidizing the sample components exiting the column in an oxidizing system adapted to convert a portion of the sample components into their corresponding oxides and where the detector/analyzer is adapted to detect one or more sample component oxides as they exit the oxidizing system.

21. The method of claim 20, further comprising step of:
after the oxidizing step, reducing a portion of the oxidizes in a reducing system to reduced species and where the detector/analyzer system is adapted to detect one or more of the reduced species as they exit the reducing system.
